(19) United States
(12) Patent Application Publication
(10) Pub. No.: US 2020/0274350 A1
(43) Pub. Date: Aug. 27, 2020

(54) EMERGENCY SHUTDOWN OF AN ENERGY SUPPLY UNIT

(71) Applicant: SMA Solar Technology AG, Niestetal (DE)

(72) Inventors: Claus Allert, Kaufungen (DE); Thomas Wegener, Kassel (DE); Dietrich Linke, Kassel (DE)

(21) Appl. No.: 15/930,625

(22) Filed: May 13, 2020

Related U.S. Application Data
(63) Continuation of application No. PCT/EP2018/081656, filed on Nov. 16, 2018.

(30) Foreign Application Priority Data
Nov. 17, 2017 (DE) 102017127082.5

(51) Int. Cl. H02H 7/18; H02J 7/00

(52) U.S. Cl. CPC H02H 7/18; H02J 7/0031; H02J 7/00302

(57) ABSTRACT

A power supply apparatus includes at least one inverter, and at least one battery connected to the inverter. The inverter includes a control device, an AC-side connection for a grid, and at least one DC battery connection for connecting the at least one battery and an inverter bridge. Two poles of the battery are connected to the DC battery connection of the inverter via supply lines for the purpose of charging and discharging the battery, and a control line is connected to the battery. The apparatus also includes a shutdown apparatus. The power supply apparatus is configured, in an operating state and due to a shutdown control action of the shutdown apparatus, to shut down or prevent at least a clocking of an inverter bridge of the inverter, and to remove an enabling signal, applied to the control line, for the battery such that the battery opens at least one connection for charging and discharging the battery between at least one of its two poles and the inverter.

### CROSS REFERENCE TO RELATED APPLICATIONS

This application is a continuation of International Patent Application number PCT/EP2018/081656, filed on Nov. 16, 2018, which claims priority to German Patent Application number 10 2017 127 082.5, filed on Nov. 17, 2017, and is hereby incorporated by reference in its entirety.

### FIELD

The disclosure relates to a method for changing an operating state of a power supply apparatus. The power supply apparatus comprises at least one inverter, connectable on the AC side to a grid, and at least one battery connected to the inverter.

### BACKGROUND

Power supply apparatuses of this kind can, for example, buffer-store electrical energy of a public grid and/or from solar modules and/or from wind turbines in the battery in the operating state. The electrical energy can be made available again when needed, for example to support the public grid or for an emergency power supply. The inverter converts DC voltage into AC voltage, and vice versa. To charge and discharge the battery, said inverter transports electrical energy in both directions, that is to say for example from the AC-side connection to the battery, and vice versa.

Power supply apparatuses are known from the prior art that, for example, respond to a demand of a public grid by making additional real power available by virtue of the power supply apparatus starting a discharge process of the battery.

There can, for example, also be provision for a change of operation for a power supply device of a domestic installation that comprises a solar installation and is additionally designed for island operation. The power supply apparatus shuts down the battery, for example, or switches it to an idle mode (standby mode) when the battery has reached a lower charging limit and at the same time the battery is not expected to be charged by the solar installation, e.g. at night.

### SUMMARY

The disclosure is directed to a method and a power supply apparatus suitable for performing the method that can be used to shut down at least part of the power supply apparatus, and/or to transfer at least part of it to a standby mode, particularly safely.

The power supply apparatus comprises a control line, connected to the battery, and a shutdown apparatus. The power supply apparatus is configured, in an operating state, to take a shutdown control action on the shutdown apparatus as a basis for shutting down and/or preventing at least one clocking of the inverter bridge and removing an enabling signal, applied to the control line, for the battery such that the battery opens at least one connection for charging and discharging the battery between at least one of its two poles and the inverter.

According to the disclosure, it is therefore proposed that provision be made for a shutdown apparatus for the power supply apparatus in an operating state and that a shutdown control action on the shutdown apparatus be taken as a basis for influencing both the clocking of at least the inverter bridge and the battery.

The shutdown process can therefore be actively initiated by a shutdown control action on the shutdown apparatus. Such a shutdown option increases safety during operation of such a power supply apparatus. The shutdown control action can be performed by remote control from a monitoring control room and/or manually in situ, for example, and consist in the operation of a switch or key of the shutdown apparatus, for example. The inverter is deenergized at the DC battery connection and the AC-side connection following the shutdown process, which means that the voltages at the inputs and outputs of the inverter with reference to one another and with reference to ground do not exceed the level of safety extra-low voltages (e.g., 30V).

The shutdown apparatus can be comprised by the inverter or another component of the power supply apparatus, for example, or there is a provision for a connection between the shutdown apparatus and the inverter and/or another component of the power supply apparatus. The shutdown apparatus can, for example, take the shutdown control action as a basis for providing a control signal that is applied to a control assembly of the inverter, for example. Within the context of this disclosure, the control assembly can also be referred to as control device or controlling device or control/controlling device or controlling assembly or control/controlling assembly or controller. According to this example embodiment, the control signal prompts the control device to finish the clocking of at least the inverter bridge. If the inverter comprises at least one further DC/DC chopper in addition to the inverter bridge, the control device can also be configured such that the control signal prompts the control device to shut down and/or prevent the clocking of the power semiconductor switches of the inverter bridge and of the at least one further DC/DC chopper, in both cases by virtue of software having an appropriate function being implemented on a microcontroller of the control assembly, for example. The control device can appropriately influence the drivers of the power semiconductor switches of the inverter, for example, so that a clocking of the power semiconductor switches is shut down. The control device could alternatively open a respective control line of the drivers to the respective power semiconductor switch and hence prevent a clocking of the power semiconductor switches.

The further reaction to the shutdown control action on the shutdown apparatus, namely the removal of the enabling signal on the control line of the battery, can be realized, for example, by virtue of the shutdown apparatus, for example, directly having a signal line to a switch that takes a shutdown control signal of the shutdown apparatus as a basis for opening the control line. Alternatively, the shutdown apparatus influences the component of the power supply apparatus that makes the enabling signal available on the control line in the operating state. By way of example, the component can be the inverter or a separate backup device of the power supply apparatus. In the first case, the control device of the inverter can take the signal of the shutdown apparatus as a basis for not only shutting down at least the clocking of the inverter bridge but also shutting down a provision of the enabling signal on the control line of the battery. By way of example, the enabling signal can be connected to a connection of the inverter for the control line by the control device in the operating state, so that the control device is also configured to shut down the enabling signal.

Within the context of this disclosure, the term “removal” of the enabling signal comprises shutting down and/or altering and/or preventing the enabling signal. The essential aspect in this case is only that the battery interprets the removal of the enabling signal such that the battery opens the connection between its two poles in the inverter such that there is no longer a possibility of a flow of current between the battery and the inverter, for example by virtue of the battery opening a connection for charging and discharging the battery between at least one of the two poles and the inverter. If one of the two poles is grounded, the battery can in particular open the connection between the other pole and the inverter. By way of example, the battery can be designed so that, in the event of an enabling signal not being applied, the battery changes to a standby mode and, in the event of this change of operating state, also opens the at least one connection for charging and discharging the battery to the inverter.

Within the context of this disclosure, the enabling signal can also be referred to as Active signal or Enabling signal. The control line connected to the battery can also be referred to as Enable line. After the shutdown process, the power supply apparatus according to the disclosure is in a state in which the inverter is deenergized at its AC-side connection or has only a low voltage value. The same applies to the DC-side battery connection. If the inverter has multiple DC battery connections, the respective enabling signal on the corresponding control line of the battery can be removed for each of the batteries. To increase safety, a connection from the inverter to a solar installation and/or a grid can additionally be cut. If the power supply apparatus comprises multiple such inverters, the shutdown apparatus can be of appropriate design for all of these inverters or it is possible for multiple such shutdown apparatus to be comprised, the former instance allowing shutdown with particularly low operator involvement.

Advantageous refinements of the disclosure are specified in the description, the features of which can be used individually and in any combination with one another.

One advantageous refinement of the disclosure can provide for the battery to comprise a battery management system and a protection circuit, actuatable by the battery management system, comprising at least one switch for interrupting such a connection for charging and discharging the battery.

The control line can be connected to the battery management system, for example. In an operating state, in which the control line has the enabling signal applied to it, when the enabling signal is removed by means of the battery management system, the battery can actuate the protection circuit such that it opens applicable switches in at least one of the supply lines in order to sever a conductive connection to the inverter. In particular, the battery management system can be configured so as, when the enabling signal is removed, to put the battery into a standby mode, the battery management system also interrupting the connection to the inverter in the course of this change of operation.

One advantageous refinement of the disclosure can provide for the power supply apparatus to be configured so as, in an operating state, to take a shutdown control action on the shutdown apparatus as a basis for shutting down and/or preventing a clocking of the power semiconductor switches of the at least one converter that the inverter comprises.

If the inverter comprises further converters such as for example a DC/DC chopper in addition to the inverter bridge, this refinement of the disclosure involves a shutdown control action on the shutdown apparatus being taken as a basis for also shutting down and/or preventing the clocking of the further converters. By way of example, the control device of the inverter and the shutdown apparatus can be designed such that a shutdown control action on the shutdown apparatus results in a shutdown signal being provided to the control device by the shutdown apparatus, so that the control device shuts down and/or prevents the clocking of the power semiconductor switches.

It can also be regarded as advantageous that the shutdown apparatus is at least manually operable.

This allows the power supply apparatus to be shut down by a person in situ, for example in the event of a fire. The shutdown apparatus can be arranged separately, for example in an easily accessible area such as a hallway. The shutdown apparatus can also be combined with what is known as a fireman's switch of a solar installation, which can be used to disconnect a solar installation from a domestic installation and to switch the outputs of the solar modules to a safe state.

A further advantageous refinement of the disclosure can provide for the shutdown apparatus to take a shutdown control action as a basis for providing at least one signal.

The signal can be applied to one or more signal lines. The signal can be configured for transmission via a field bus. The signal could alternatively be a pure voltage value or the interruption of the provision of a voltage value on a signal line. By way of example, the shutdown apparatus could be designed such that it opens a signal line that has both ends connected to the inverter and has a signal applied to it by the inverter. If the shutdown apparatus opens the signal line, which in this case can be in the form of an Enable line of the inverter, the shutdown signal transmitted is the removal of the signal. At least one signal of the shutdown apparatus could also be in the form of a hardware signal or be configured for further processing by means of software.

According to a further advantageous refinement of the disclosure, the shutdown apparatus can be arranged separately.

In this context, separately is supposed to denote just a local separation of the main components of the power supply device, that is to say the inverter or a backup device that may be present or the at least one battery. This allows the shutdown apparatus to be arranged in easily accessible fashion.

It can also be regarded as advantageous that a signal line running from the shutdown apparatus to the inverter is comprised, and the shutdown apparatus and the inverter are configured such that, in an operating state of the power supply apparatus, a shutdown control action on the shutdown apparatus is taken as a basis for applying a signal provided by the shutdown apparatus to the signal line, so that the control device of the inverter shuts down and/or prevents at least one clocking of the inverter bridge.

According to this requirement of the disclosure, the control signal prompts the control device to finish the clocking of at least the inverter bridge, for example, by virtue of software with an appropriate function being implemented on a microcontroller of the control assembly. The control device can appropriately influence the drivers of the power semiconductor switches of the inverter bridge and any DC choppers of the inverter that are present, for example, so that a clocking of the power semiconductor switches is shut down. The control device could alternatively open a respective control line of the drivers to the respective power semiconductor switch and hence prevent a clocking of the power semiconductor switches. The signal provided by the shutdown apparatus could alternatively be a hardware signal that is forwarded within the inverter to respective hardware signal inputs of the drivers. This forwarding of the signal within the inverter is also meant to be covered by the term control device within the context of this disclosure.

Advantageously, there can further be provision for the control line connected to the battery to be connected to the inverter, and for the control device to additionally remove an enabling signal provided on the control line by the inverter such that the battery opens at least one connection for charging and discharging the battery between at least one of its two poles and the inverter.

According to this requirement of the disclosure, on receiving the signal of the shutdown apparatus, the inverter reacts both by shutting down and/or preventing the clocking of at least the inverter bridge and by removing the enabling signal on the control line of the battery. The order of the two reactions is unimportant in this case.

It can also be regarded as advantageous that the power supply apparatus comprises a backup device comprising a control module. The control line connected to the battery is connected to the backup device, wherein the power supply apparatus is configured such that in an operating state of the power supply apparatus, a shutdown control action on the shutdown apparatus is taken as a basis for the control module to remove an enabling signal provided on the control line by the backup device such that the battery opens at least one connection for charging and discharging the battery between at least one of its two poles and the inverter.

According to this refinement of the disclosure, the control line of the battery has the enabling signal applied to it by the backup device in the operating state. The backup device can be comprised by the inverter or for example arranged separately. The backup device can comprise or actuate sensors and/or contactors, for example. The backup device has a control module, wherein the control module can comprise a microcontroller. The control module can also be referred to as control device. The backup device can be designed so as, in interaction with the bidirectional inverter, to allow an emergency mode in a local grid in the event of a failure of a public grid. To this end, the backup devices can be designed to detect a failure of the public grid and to isolate the local grid, connected to the AC side of the inverter, from the public grid, among other things.

The chain of reaction on the basis of the shutdown control action on the shutdown apparatus can run via the inverter, for example by virtue of the shutdown apparatus providing the inverter with a shutdown signal that prompts the inverter not only to finish the clocking of at least the inverter bridge but also to instruct the separate backup device, via a field bus connection, to remove the enabling signal for the battery on the control line. To this end, the control device of the inverter and the control module of the backup device can be of appropriate design, and a field bus having the appropriate interfaces can be present on the two devices. The chain of reaction could alternatively be of more direct design, for example by virtue of the shutdown apparatus taking a shutdown control action as a basis for also providing a signal on a signal line connected to the backup device, which signal is converted by the control module as appropriate. Direct actuation of a switch in the control line of the battery by the shutdown apparatus is likewise possible.

It can also be regarded as advantageous that the power supply apparatus is configured so as, in an operating state, to take a shutdown control action on the shutdown apparatus as a basis for shutting down and/or preventing a clocking of the inverter bridge, and removing an enabling signal, applied to the control line, for the battery, independently of a disconnection of the inverter from a solar installation and/or a supply grid.

This feature once again serves to clarify the inventive fundamental idea that the chain of reaction between the shutdown apparatus and the inverter does not proceed indirectly by virtue of the shutdown apparatus opening a grid isolating switch and said opening being detected by the inverter and this then causing shutdown of the clocking of the inverter bridge. Rather, the chain of reaction—according to the advantageous refinement of the disclosure—between the shutdown apparatus and the inverter proceeds directly by means of a control signal and by means of the control device of the inverter on a software basis, as a result of which a faster reaction is obtained than in the case of a chain of reaction that proceeds via the opening of a grid isolating switch.

It can also be regarded as advantageous that the power supply apparatus is configured such that, in an operating state, a shutdown control action on the shutdown apparatus is taken as a basis for:
actuating a control device of the inverter by means of the shutdown apparatus in order to shut down and/or prevent a clocking of the inverter bridge, and
actuating a component of the power supply apparatus, which component provides the enabling signal for the battery that is applied to the control line, by means of the shutdown apparatus in order to remove the enabling signal.

According to this refinement of the disclosure, the chain of reaction between the shutdown apparatus and the component of the power supply apparatus that provides the enabling signal on the control line for the battery also proceeds directly via a control signal from the shutdown apparatus to the component and is software based by means of the control of the component, so that a fast reaction is made possible. In particular, the component can be identical to the inverter if the latter provides the enabling signal on the control line for the battery.

A further feature of the disclosure is to specify an inverter that is usable as part of the power supply apparatus so that at least part of the power supply apparatus can be shut down, or at least part of it can be transferred to a standby mode, particularly safely.

In one embodiment, the inverter comprises a control device, an AC-side connection for a grid, at least one DC battery connection for connecting at least one battery and an inverter bridge, wherein the DC battery connection has at least one interface for a connection for charging and discharging the battery. The inverter is designed and configured such that it is useable as part of a power supply device.

In one embodiment, the inverter can have an interface for a signal line of the shutdown apparatus or can comprise the shutdown apparatus. When a shutdown signal is applied to the signal line, a control device of the inverter can be configured such that the control device shuts down and/or prevents the clocking of the inverter bridge and possibly of further DC choppers. Additionally, the inverter is able, in the operating state, to provide an enabling signal on the control line of the battery, so that for example the control device can be configured to also remove the enabling signal when the shutdown signal is applied.

In regard to the advantages, definitions and terms, example embodiments and methods of operation of the inverter according to the disclosure, reference is also made to the explanations above in regard to the apparatus, which are applicable in an analogous manner to the inverter and its advantageous configurations.

It is a further feature of the disclosure to specify a shutdown apparatus comprising an operating means for shutting down a power supply apparatus, which shutdown apparatus is useable as part of the power supply apparatus so that at least part of the power supply apparatus can be shut down, or at least part of it can be transferred to a standby mode, particularly safely.

In one embodiment, the shutdown apparatus is designed and configured such that a shutdown control action on the operating means results in a signal being provided by the shutdown apparatus, and the shutdown apparatus is useable as part of the power supply apparatus.

The operating means can have one or more switching positions for manual operation, at least one switching position being designed for the shutdown. The operating means could alternatively consist in an interface for remotely controlling the shutdown apparatus. The shutdown apparatus can be combined for example with a further switching apparatus, for example with an apparatus for starting up the power supply apparatus from a shut-down state.

In regard to the advantages, definitions of terms, example embodiments and methods of operation of the shutdown apparatus according to the disclosure, reference is also made to the explanations above with regard to the apparatus, which are applicable in an analogous manner to the shutdown apparatus and its advantageous configurations.

It is a further feature of the disclosure to specify a backup device comprising a control module, which backup device is useable as part of the power supply apparatus, so that at least part of the power supply apparatus can be shut down, or at least part of it can be transferred to a standby mode, particularly safely.

To this end, the backup device comprises at least one output interface for connecting a control line of a battery, wherein the backup device is configured so as, in the operating state, to provide an enabling signal on the output interface, and the backup device is designed and configured such that it is useable as part of the power supply apparatus.

In regard to the advantages, definitions of terms, example embodiments and method of operation of the backup device according to the disclosure, reference is also made to the explanations above in regard to the apparatus, which are applicable in an analogous manner to the backup device and its advantageous configurations.

The backup device can be comprised by the inverter or can be arranged separately. In the latter case, the backup device comprises at least one input interface for a supply voltage, for example for connecting a supply line from the inverter. The backup device can comprise the shutdown apparatus. If a power supply apparatus comprising a shutdown apparatus arranged separately from the backup device is involved, the backup device comprises at least one input interface for receiving a shutdown signal, since the control line of the battery, according to this refinement of the disclosure, has an enabling signal applied to it by the backup device in an operating state. The shutdown signal can be transmitted directly from the shutdown apparatus, for example by means of a signal line, to the backup device. Alternatively, the chain of reaction can take place via the inverter, for example. The terms “input interface” and “output interface” are used for better distinguishability. It is entirely possible in this case for the interfaces to be configured such that signals and/or data and/or voltages are transmittable via said interfaces in both directions.

It is a further feature of the disclosure to specify a method of the type cited at the outset for shutting down a power supply apparatus from an operating state, which method can be used to shut down at least part of the power supply apparatus, or to transfer at least part of it to a standby mode, particularly safely.

The power supply apparatus comprises at least one inverter, connectable on the AC side to a grid, and at least one battery connected to the inverter. The method according to the disclosure involves a shutdown control action on a shutdown apparatus comprised by the power supply apparatus being performed, and the shutdown control action being taken as a basis for shutting down and/or preventing at least one clocking of the inverter bridge, and an enabling signal for the battery that is applied to a control line of the battery being shut down or altered and/or prevented such that the battery severs at least one connection for charging and discharging the battery between at least one of its two poles and the inverter.

In regard to the advantages, definitions of terms, example embodiments and modes of operation of the method according to the disclosure, reference is made to the explanations above in regard to the apparatus, which are applicable in an analogous manner to the method and its advantageous configurations.

### BRIEF DESCRIPTION OF THE DRAWINGS

Further expedient refinements and advantages of the disclosure are the subject of the description of example embodiments of the disclosure with reference to the figure of the drawings, wherein identical reference signs denote subassemblies having identical action.

FIG. 1 schematically shows a power supply apparatus based on the prior art,

FIG. 2 schematically shows a power supply apparatus according to a first example embodiment of the disclosure,

FIG. 3 schematically shows a power supply apparatus according to a second example embodiment of the disclosure, and

FIG. 4 show a flowchart for a method according to a third example embodiment of the disclosure.

### DETAILED DESCRIPTION

The disclosure relates to a method for changing an operating state of a power supply apparatus. The power supply apparatus comprises at least one inverter, connectable on the AC side to a grid, and at least one battery connected to the inverter.

The disclosure also relates to a power supply apparatus suitable for performing the method. The power supply apparatus comprises at least one inverter and at least one battery connected to the inverter. The inverter comprises a control device, an AC-side connection for a grid, at least one DC battery connection for connecting the at least one battery and an inverter bridge. Two poles of the battery are connected to the DC battery connection of the inverter via supply lines for the purpose of charging and discharging the battery.

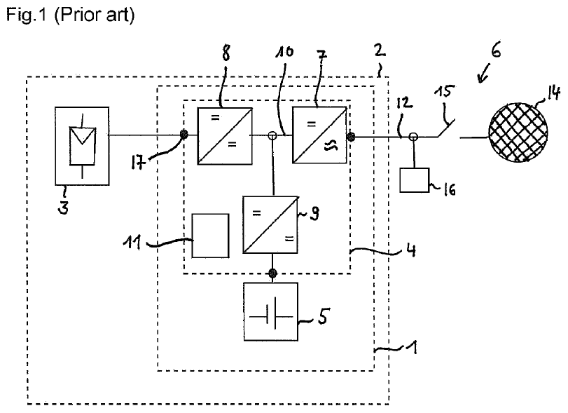

FIG. 1 schematically shows a power supply apparatus 1 based on the prior art. The power supply apparatus 1 is part of a power station 2 having a solar installation 3. The power supply apparatus 1 comprises a bidirectional inverter 4 and a battery 5, wherein the AC side of the bidirectional inverter 4 has a grid 6 connected to it and the DC side of the bidirectional inverter has the battery 5 and the solar installation 3 connected to it. The parts of the bidirectional inverter that are depicted in the figure are an inverter bridge 7, two DC input choppers 8 and 9 and also a DC link circuit 10 and a control device 11. The DC link circuit 10 comprises a DC link capacitor (not depicted). The grid 6 connected to the AC side of the bidirectional inverter 4 comprises a local grid 12 and a public grid 14. The local grid 12 can be reversibly disconnected from the public grid 14 by means of the isolating switch 15. The local grid 12 has a load 16 connected to it. The solar installation 3 is connected to a connection 17 of the bidirectional inverter 4 on the DC side.

The bidirectional inverter 4 can transport electrical energy in both directions. The battery 5 can therefore be charged with electrical energy from the grid 6 or by the solar installation 3 via the bidirectional inverter 4. Electrical energy can be supplied to the grid 6 by the solar installation 3 and the battery 5 via the inverter 4. The inverter 4 can comprise further supplementary functions, such as, for example, the provision of power to support the public grid 14 or optimization of an operating point of the solar installation 3 (MPP tracking).

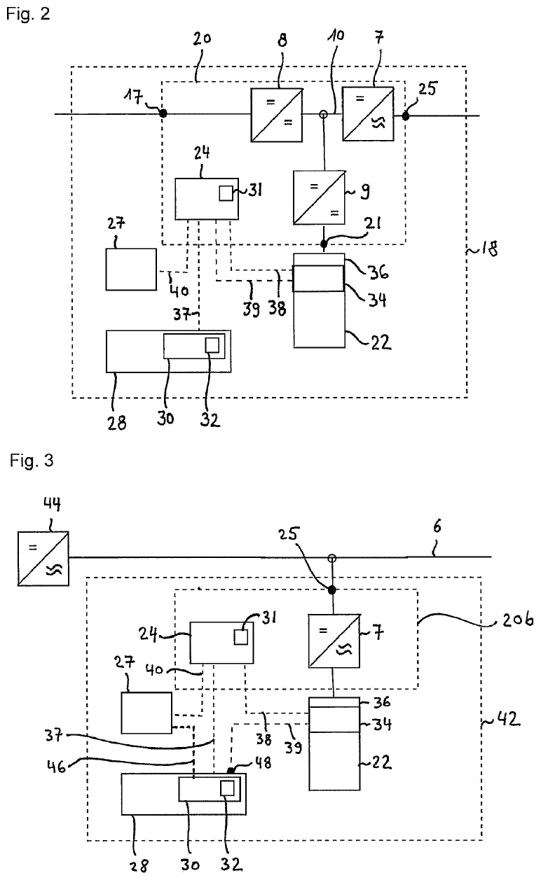

FIG. 2 schematically shows a power supply apparatus 18 according to a first example embodiment of the disclosure. The power supply apparatus 18 comprises an inverter 20 and a battery 22 connected to the inverter. The inverter 20 comprises an inverter bridge 7 and two DC input choppers 8 and 9, all three of which are connected to one another via a DC link circuit 10 of the inverter 20. As further parts of the inverter 20, the figure shows a control device 24, a DC battery connection 21, an AC-side connection 25 for connecting a grid (not depicted) and a DC-side connection 17 for connecting a solar installation (not depicted). To charge and discharge the battery 22, two poles of the battery are connected to the DC battery connection 21 of the inverter 20 via supply lines.

The power supply apparatus 18 additionally comprises a shutdown apparatus 27 arranged separately from the inverter 20 and a backup device 28 comprising a control circuit or module 30. Both the control device 24 and the control module 30 are equipped with a microcontroller, which in this instance is denoted by the reference sign 31 or 32, respectively. The subcomponents of the battery 22 that are depicted are a battery management system 34 and a protection circuit 36. Depicted coming from the control device 24 are a field bus connection 38 running to the battery 22 and a field bus connection 37 running to the backup device 28, so that communication can take place between the control device 24 and the battery 22 or the backup device via the respective field bus connection. A control line 39 of the battery 22 is likewise connected to the control device 24 of the inverter 20. This control line 39 is used by the inverter 20 in an operating state to make an enabling signal available to the battery 22. The enabling signal can also be referred to as Enable signal. The shutdown apparatus 27 is connected to the control device 24 of the inverter via a signal line 40. This signal line 40 is used by the shutdown apparatus to make a shutdown signal available to the inverter in the event of a shutdown control action.

In the example embodiment depicted, the battery 22 is designed such that disappearance of the enabling signal on the control line 39 results in the battery management system 34 actuating the protection circuit 36 such that it severs a connection between the two poles of the battery and the inverter and the battery 22 shuts down. As a result, charging and discharging of the battery 22 via the DC battery connection 21 are no longer possible in this shut-down state.

In the depicted example embodiment of the disclosure, a shutdown control action on the shutdown apparatus 27 results in a shutdown signal being made available to the control device 24 of the inverter 20 via the signal line 40, which shutdown signal prompts the control device 24 to shut down the clocking of the power semiconductor switches of the inverter bridge 7 and the DC input choppers 8 and 9 by means of appropriate actuation of the drivers of the power semiconductor switches. Additionally, the control device 24 is prompted by the shutdown signal of the shutdown apparatus to shut down an enabling signal for the battery 22 that is provided on the control line 39 by the control device. According to the example embodiment depicted the battery 22 is therefore prompted to open a connection between its two poles and the inverter 20, by opening suitable switches in the protection circuit 36, not directly by the shutdown apparatus 27 but rather indirectly by the control device 24. After the shutdown process, the inverter is therefore deenergized at the DC-side battery connection 21 and the AC-side connection 25 and also the DC-side connection 17, or now has only a voltage that is not dangerous to human beings. Optionally, the control device 24 can also be designed so as, after receiving the shutdown signal from the shutdown apparatus 27, to actuate suitable switches in the region of the AC-side connection 25 and the DC-side connection 17 and to open said switches in order to disconnect the inverter 20 from a solar installation and a grid that are connected to the inverter. This allows safety of operation in the region of the power supply apparatus 18 to be increased further still.

FIG. 3 schematically shows a power supply apparatus 42 according to a second example embodiment of the disclosure. The power supply apparatus 42 comprises an inverter 20b, a battery 22 connected to the inverter, a shutdown apparatus 27 and a backup device 28 arranged separately from the inverter. In contrast to the depiction of FIG. 2, the inverter 20b has only an inverter bridge 7 and a control device 24 and no additional DC/DC choppers. The inverter 20b is connected at an AC-side connection 25 to a grid 6 to which AC voltage can be applied, wherein the battery 22 connected to the inverter 20b can be charged with energy from the grid 6 via the inverter 20b and, in the opposite direction, is able to supply energy to the grid 6. For the purpose of supplying solar energy, there is additionally also a solar inverter 44 connected to the grid 6. In contrast to FIG. 2, the control line 39 of the battery is now connected to the separate backup device 28 and has an enabling signal applied to it by the latter at an output interface 48 in an operating state of the power supply apparatus 42. From the shutdown apparatus 27, a signal line 40 runs to the control device 24 of the inverter 20b, as previously. In contrast to FIG. 2, an additional signal line 46 runs to the backup device 28. The power supply apparatus 42 is configured so that, in an operating state of the power supply apparatus, a shutdown control action is taken as a basis by the shutdown apparatus 27 for providing a shutdown signal on the signal lines 46 and 40. The control module 30 of the backup device 28 is configured such that reception of the shutdown signal results in the control module 30 shutting down the enabling signal provided at the output interface 48. Owing to the disappearance of the enabling signal, the battery 22, as already described for FIG. 2, opens a connection between the two poles of the battery and the DC battery connection 21 of the inverter 20b. According to the example embodiment depicted, the control device 24 is configured so as, on receiving the shutdown signal on the signal line 40, to shut down the clocking of the inverter bridge 7, for example by virtue of the control device 24 actuating the drivers of the power semiconductor switches of the inverter bridge 7 as appropriate.

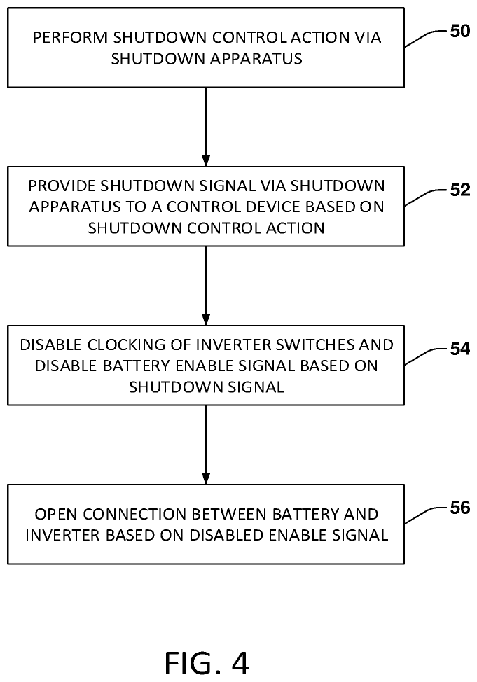

FIG. 4 shows a flowchart for a method for shutting down a power supply apparatus from an operating state according to a third example embodiment of the disclosure. The power supply apparatus comprises at least one inverter, which is connectable on the AC side to a grid and has an inverter bridge, and at least one battery connected to the inverter. In a method act 50, a shutdown control action on a shutdown apparatus that the power supply apparatus comprises is performed. In a method act 52, a shutdown signal is provided by the shutdown apparatus on the basis of the shutdown control action and is conveyed to a control device of the inverter. In a method act 54, the control device of the inverter takes the shutdown signal as a basis for shutting down the clocking of the power semiconductor switches that the inverter comprises and an enabling signal for the battery, and, in a method act 56, the battery severs a connection between its two poles and the inverter on the basis of the disappearance of the enabling signal. After the shutdown process, the power supply apparatus is in a state in which the inverter provides no further voltage on the AC side and the DC side.

1. A power supply apparatus, comprising:
at least one inverter;
at least one battery connected to the inverter, wherein the inverter comprises:
a control device,
an AC-side connection for a grid,
at least one DC battery connection for connecting the at least one battery and an inverter bridge, and
wherein two poles of the battery are connected to the DC battery connection of the inverter via supply lines for the purpose of charging and discharging the battery,
a control line connected to the battery, and
a shutdown apparatus,
wherein the power supply apparatus is configured, in an operating state and due to a shutdown control action of the shutdown apparatus, to shut down or prevent at least a clocking of an inverter bridge of the inverter, and to remove an enabling signal, applied to the control line, for the battery such that the battery opens at least one connection for charging and discharging the battery between at least one of its two poles and the inverter.

2. The power supply apparatus as claimed in claim 1, wherein the battery comprises a battery management system and a protection circuit, actuatable by the battery management system, comprising at least one switch for opening the at least one connection for charging and discharging the battery.

3. The power supply apparatus as claimed in claim 1, wherein the power supply apparatus is configured, in an operating state and due to the shutdown control action of the shutdown apparatus, to shut down or prevent a clocking of power semiconductor switches of the inverter bridge.

4. The power supply apparatus as claimed in claim 1, wherein the shutdown apparatus is at least manually operable.

5. The power supply apparatus as claimed in claim 1, wherein the shutdown apparatus is configured to provide at least one signal due to a shutdown control action.

6. The power supply apparatus as claimed in claim 1, wherein the shutdown apparatus is arranged separately from the power supply apparatus.

7. The power supply apparatus as claimed in claim 1, further comprising a signal line running from the shutdown apparatus to the inverter, and the shutdown apparatus and the inverter are configured, in an operating state of the power supply apparatus and due to the shutdown control action of the shutdown apparatus, provide a signal to the signal line, so that the control device of the inverter shuts down or prevents at least one clocking of the inverter bridge.

8. The power supply apparatus as claimed in claim 7, wherein the control line connected to the battery is connected to the inverter, and the control device is additionally configured to remove an enabling signal provided on the control line by the inverter such that the battery opens at least one connection for charging and discharging the battery between at least one of its two poles and the inverter.

9. The power supply apparatus as claimed in claim 1, further comprising:
a backup device having a control module, and
the control line connected to the battery is connected to the backup device,
wherein the power supply apparatus is configured, in an operating state of the power supply apparatus, to initiate the shutdown control action of the shutdown apparatus in order for the control module to remove an enabling signal provided on the control line by the backup device such that the battery opens at least one connection for charging and discharging the battery between at least one of its two poles and the inverter.

10. An inverter, comprising:
a control device,
an AC-side connection for a grid,
an inverter bridge and at least one DC battery connection for connecting at least one battery,
wherein the DC battery connection comprises at least one interface configured to connect the at least one battery for charging and discharging the at least one battery, and
wherein the inverter is configured to operate as part of a power supply apparatus that comprises: the inverter;
at least one battery connected to the inverter, wherein the inverter comprises:
a control device,
an AC-side connection for a grid,
at least one DC battery connection for connecting the at least one battery and an inverter bridge, and
wherein two poles of the battery are connected to the DC battery connection of the inverter via supply lines for the purpose of charging and discharging the battery,
a control line connected to the battery, and
a shutdown apparatus,
wherein the power supply apparatus is configured, in an operating state and due to a shutdown control action of the shutdown apparatus, to shut down or prevent at least a clocking of an inverter bridge of the inverter, and to remove an enabling signal, applied to the control line, for the battery such that the battery opens at least one connection for charging and discharging the battery between at least one of its two poles and the inverter.

11. A shutdown apparatus comprising an operating means for shutting down a power supply apparatus, wherein the shutdown apparatus is designed and configured such that
at least one signal is provided due to a shutdown control action of the operating means of the shutdown apparatus, and
the shutdown apparatus is useable as part of the power supply apparatus, comprising: at least one inverter;
at least one battery connected to the inverter, wherein the inverter comprises:
a control device,
an AC-side connection for a grid,
at least one DC battery connection for connecting the at least one battery and an inverter bridge, and
wherein two poles of the battery are connected to the DC battery connection of the inverter via supply lines for the purpose of charging and discharging the battery,
a control line connected to the battery, and
a shutdown apparatus,
wherein the power supply apparatus is configured, in an operating state and due to a shutdown control action of the shutdown apparatus, to shut down or prevent at least a clocking of an inverter bridge of the inverter, and to remove an enabling signal, applied to the control line, for the battery such that the battery opens at least one connection for charging and discharging the battery between at least one of its two poles and the inverter.

12. A power supply apparatus, comprising:
an inverter comprising an inverter bridge circuit configured to selectively switch one or more switches based on a clocking signal;
a control circuit configured to selectively enable or disable the clocking signal;
a shutdown circuit configured to identify a shutdown condition and selectively output a shutdown signal on a signal line to the control circuit upon identification of the shutdown condition;
a battery system configured to selectively connect to the inverter based on an enable signal on a control line from the control circuit,
wherein the control circuit is configured to disable the clocking signal to the inverter and disable the enable signal on the control line to the battery system when the shutdown signal on the signal line indicates a shutdown condition.

13. The power supply apparatus of claim 12, wherein the inverter bridge circuit stops operating when the clocking signal is disabled.

14. The power supply apparatus of claim 12, wherein the battery system disconnects from the inverter when the enable signal is disabled.

15. The power supply apparatus of claim 12, wherein the battery system further comprises:
a battery management circuit; and
a protection circuit,
wherein the protection circuit comprises one or more switches that connect a battery store of the battery system to the inverter, and
wherein the battery management circuit is configured to open at least one of the one or more switches when the enable signal is disabled on the control line.
